(19) United States
(12) Patent Application Publication
(10) Pub. No.: US 2026/0326639 A1
(43) Pub. Date: Oct. 22, 2026

(54) A VEHICLE SEAT

(71) Applicant: NMI SAFETY SYSTEMS LTD., Stevenage Hertfordshire (GB)

(72) Inventor: Michael Sawdy, Stevenage Hertfordshire (GB)

(21) Appl. No.: 19/109,791

(22) PCT Filed: Sep. 4, 2023
(86) PCT No.: PCT/GB2023/052274

§ 371 Date: Mar. 7, 2025

(30) Foreign Application Priority Data
Sep. 8, 2022 (GB) 2213131.2

(51) Int. Cl. B60N 2/68; B60N 2/427

(52) U.S. Cl. CPC B60N 2/68; B60N 2/42745

(57) ABSTRACT

A seat frame, comprising: a squab support; a seat back frame, fixed in place with respect to the squab support at a first angle by a fastener; and a deformable element having an upper portion and a lower portion and an aperture through which the fastener passes, wherein: the deformable element further has a gap having an initial width, the gap being formed between the upper and lower portions; the deformable element may permanently deform, upon rotation of the seat back frame with respect to the squab support around the fastener, so that the upper and lower parts of the deformable element rotate with respect to each other about the fastener, and the width of the gap reduces, so that the seat back frame is at a second angle with respect to the squab support.

This invention relates to vehicle seats. The invention is particularly, but not exclusively, concerned with seats for use in buses, coaches and other passenger vehicles.

Vehicle seats typically comprise a sturdy frame made from metal, which is at least partially surrounded by a padding material such as polyurethane (PE) foam, and then upholstered with an outer layer of fabric, plastic or any other suitable material.

The frame of the seat serves to provide the necessary strength and rigidity to support the seat occupant, and also helps to protect the seat occupant in the event of a crash.

Current designs of seat frame can be difficult and time consuming to construct.

In the event of a head-on collision, conventional seat frames also transmit a large proportion of the resulting forces to the seat occupant.

It is an object of the invention to provide an improved seat frame for a vehicle seat.

Accordingly, one aspect of the present invention provides A seat frame, comprising: a squab support; a seat back frame, fixed in place with respect to the squab support at a first angle by a fastener; and a deformable element having an upper portion and a lower portion and an aperture through which the fastener passes, wherein: the deformable element further has a gap having an initial width, the gap being formed between the upper and lower portions; the deformable element may permanently deform, upon rotation of the seat back frame with respect to the squab support around the fastener, so that the upper and lower parts of the deformable element rotate with respect to each other about the fastener, and the width of the gap reduces, so that the seat back frame is at a second angle with respect to the squab support.

Advantageously, the upper portion of the deformable element is engaged with a part of the seat back frame.

Preferably, the upper portion of the deformable element contained within a tubular member which forms part of the seat back frame.

Conveniently, the lower portion of the deformable element is engaged with a part of the squab support.

Advantageously, the lower portion of the deformable element abuts or is adjacent a part of the squab support.

Preferably, the part of the squab support is a bearing surface of the squab support.

Conveniently, the gap has opposing edges, which are spaced apart from each other when the gap has the initial width, and wherein the edges move closer to each other upon deformation of the deformable element.

Advantageously, following a certain amount of deformation of the deformable element, the edges of the gap meet and abut against each other, thus providing increased resistance to further deformation of the deformable element.

Preferably, the fastener passes through an aperture in the deformable element, and the gap is in communication with the aperture.

Conveniently, one or more deformable elements are provided on each side of the seat frame.

Advantageously, two deformable elements are provided on each side of the seat frame.

Preferably, the seat frame comprises a first cross-support, which is connected at a first end to an upper region of the seat back frame, and is connected at a second end to the squab support.

Conveniently, the first cross-support extends diagonally between the first and second ends.

Advantageously, the seat frame further comprises a second cross-support, which is connected at a first end to the first cross-support, and at a second end to the squab support.

Preferably, the second cross-support extends diagonally between the first and second ends.

Conveniently, the first cross-support is connected at its second end to a first side of the squab support, and the second cross-support is connected at its second end to a second, opposite side of the squab support.

Another aspect of the invention comprises a seat frame comprising: a squab support; a seat back frame, fixed in place with respect to the squab support; a first cross-support, extending diagonally across the seat back frame; and a second cross-support, extending diagonally across the seat back frame and terminating at one end in a connection to the first cross-support.

Advantageously, the seat back frame comprises a perimeter support; the first cross-support is connected to the perimeter support at an upper end thereof; and the first cross-support is connected to the squab support at a lower end thereof.

Preferably, the second cross-support is connected to the first cross-support at an upper end thereof; and the second cross-support is connected to the squab support at a lower end thereof.

Conveniently, the majority of the components defining the perimeter support of the seat back frame have a cross-sectional shape in which the width is substantially greater than the depth.

Advantageously, all or substantially all of the components defining the perimeter support of the seat back frame have a cross-sectional shape in which the width is substantially greater than the depth.

Preferably, the first cross-support is formed from a member having a cross-sectional shape in which the width is substantially greater than the depth.

Conveniently, the second cross-support is formed from a member having a cross-sectional shape in which the width is substantially greater than the depth.

In order that the invention may be more readily understood, embodiments thereof will now be described, by way of example only, with reference to the accompanying figures, in which:

FIG. 1 shows features of a squab support suitable for use with the invention, in exploded view;

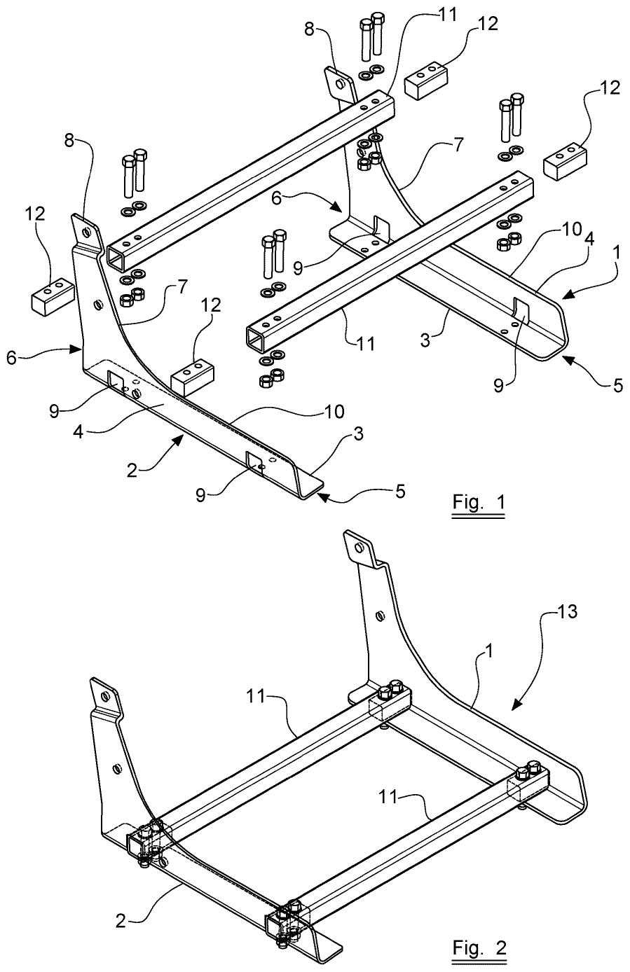

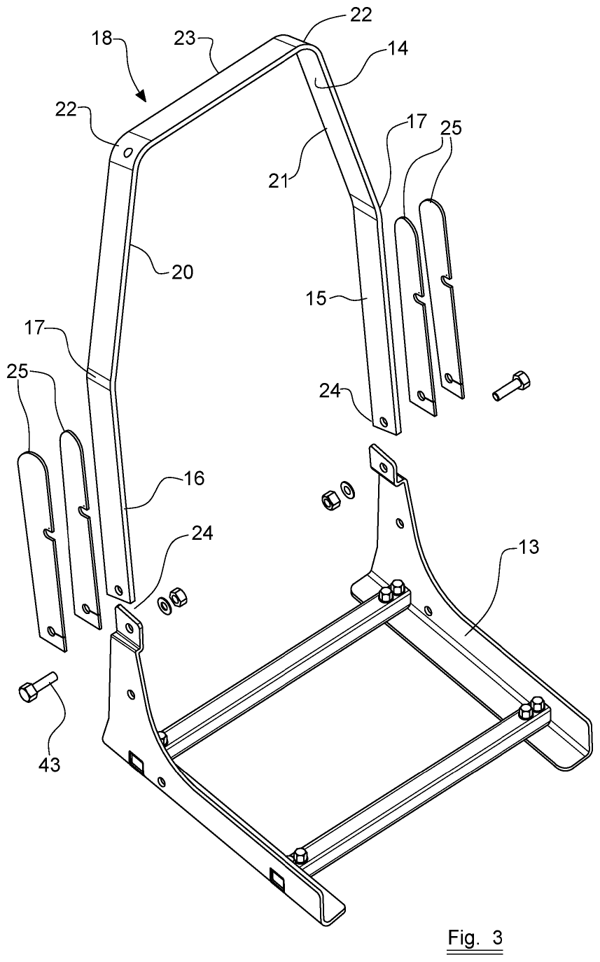

FIG. 2 shows the squab support in an assembled configuration;

FIG. 3 shows the squab support along with components of a seat back frame, in exploded view,

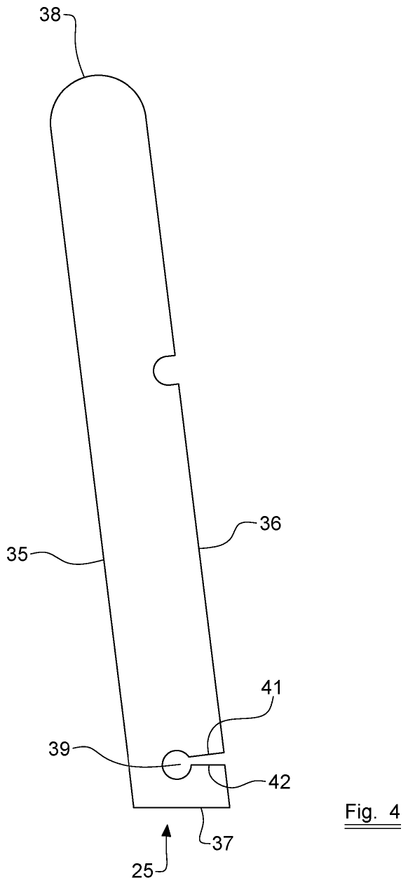

FIG. 4 is a close up view of one of the crush plates shown in FIG. 3;

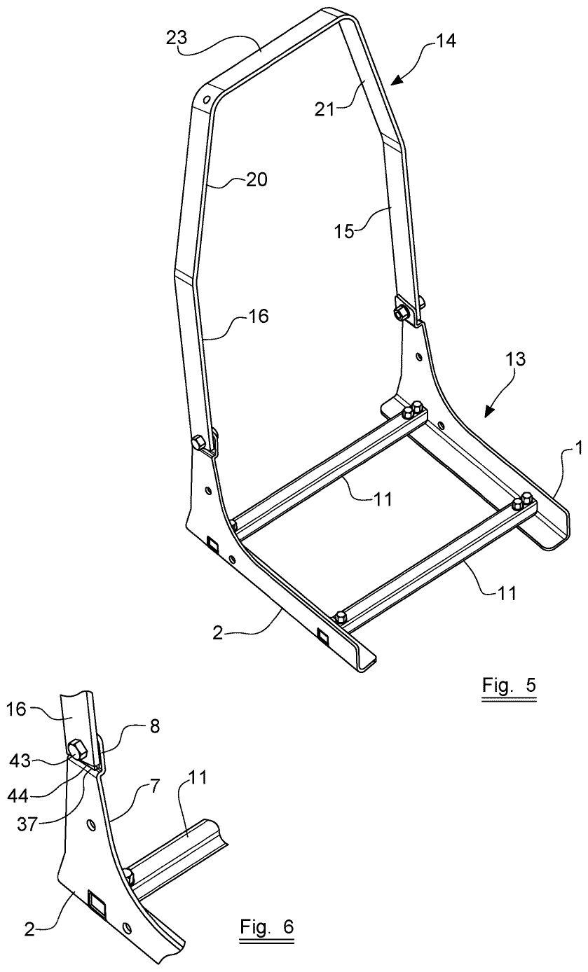

FIG. 5 shows the features of FIG. 3, in an assembled configuration;

FIG. 6 shows a close up view of a connection between the squab support and the seat back frame;

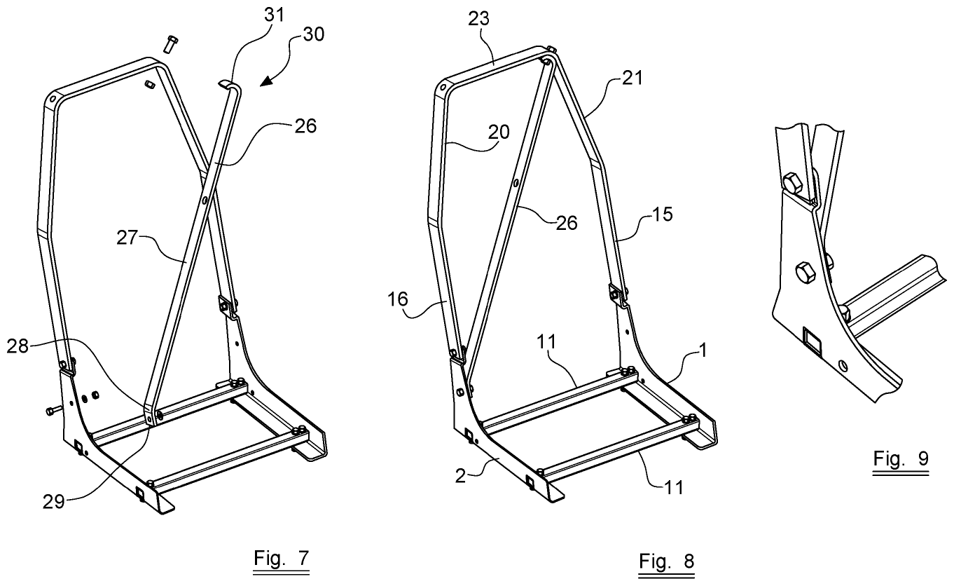

FIG. 7 shows a first cross-support, prior to connection to the squab support and seat back frame;

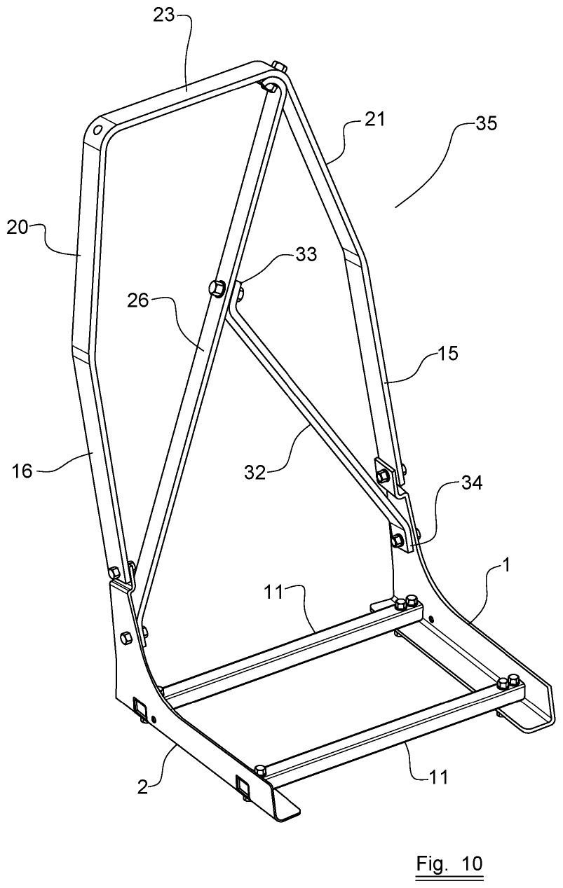

FIG. 8 shows the features of FIG. 7, in an assembled configuration;

FIG. 9 shows a close up view of a connection between first cross-support and the squab support;

FIG. 10 shows an assembled seat frame, embodying the invention; and

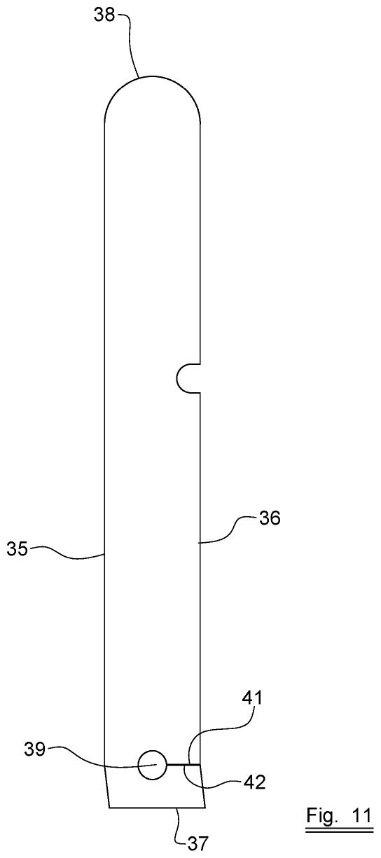

FIG. 11 shows the crush plate of FIG. 3, following a head-on collision involving the seat frame.

Referring firstly to FIG. 1, components of a squab support for a seat frame embodying the invention are shown.

These components include left and right squab side pieces 1, 2. The right squab side piece 2 is shown in phantom for the purposes of clarity.

Each of the squab side pieces 1, 2 has an elongate bottom plate 3, which in the embodiment shown is planar or substantially planar and has a generally rectangular shape. In use, the two bottom plates 3 will be arranged to be approximately horizontal, or parallel with a floor of a vehicle in which the seat is installed. Once the seat is assembled, the two bottom plates 3 are preferably in the same plane as each other.

Each squab side piece 1, 2 also has a connection plate 4. In the example shown, each connection plate 4 is at right angles, or substantially right angles, with respect to the bottom plate 3. When the seat is assembled, each connection plate 4 is preferably oriented in a vertical or substantially vertical plane.

The connection plates 4 are preferably formed integrally together with the bottom plates 3, although in other embodiments these components may be formed separately and then joined together.

Each squab side piece 1, 2 has a forward end 5 which, when the seat is assembled, will point in a generally forward direction. Each squab side piece 1, 2 also has a rear end 6 which, when the seat is assembled, will point in a generally rearward direction.

In the example shown, the towards the forward end of the squab side pieces 1, 2, the connection plates 4 have a generally consistent width. This width may be approximately equal to the width of the bottom plate 3.

At its rear end 6, each of the connection plates 4 has a connection projection 7, which extends away from the bottom plate 3. This gives each connection plate 4 a generally L-shaped configuration.

The majority of each connection plate 4 is generally planar. However, in the embodiment shown, at a top end of each of the connection projections 7 (i.e. the part of the connection projection 7 which lies furthest from the bottom plate 3), there is an offset region 8, which is generally parallel with the remainder of the connection plate 4, but offset with respect thereto. In preferred embodiments, the offset portion 8 is offset with respect to the remainder of the connection plate 4 in the same direction that the bottom plate 3 extends from the connection plate 4.

An upward-facing shoulder 44 is formed between the offset portion 8 and the remainder of the connection plate 4.

In the example shown in FIG. 1, when the seat is in its assembled form, the offset portions 8 of the left and right connection plates 4 are closer to each other than the remainder of the connection plates 4.

Each of the connection plates 4 has a pair of receiving apertures 9 formed therethrough. In the embodiment shown each receiving aperture 9 has a generally rectangular form. The receiving apertures 9 are preferably formed so that one edge thereof lies on or near the junction between the bottom plate 3 and the connection plate 4. The receiving apertures 9 extend from this junction part of the way towards a top edge 10 of the connection plate 4.

One of the receiving apertures 9 is positioned towards the front end 5 of the squab side piece 1, 2, with the other receiving aperture 9 being positioned towards the rear end 6 thereof.

A pair of squab connection struts 11 is provided. Each squab connection strut 11 is intended to be fixed in place between the squab side pieces 1, 2, fixing the squab side pieces 1, 2 in place with respect to each other.

In the embodiment shown the squab connection struts 11 take the form of tubular beams, having a generally square or rectangular cross-section. One end of each of the beams is aligned with a respective one of the receiving apertures 9 formed in each of the squab side pieces 1, 2. These receiving apertures 8 are optional, and are provided in the example shown so that, if either of the connection struts is too long, the excess length can extend into one or both of the receiving apertures 8.

Throughout the specification, reference is made to components which are connected together with bolts or similar fasteners. Where two components are connected by a bolt, connection holes will be formed through both components. The bolt will pass through the holes in both of the components, and a nut or similar will be connected to one end of the bolt.

Where two components are described as being held together by bolts, for brevity the connection holes which are formed through the components will not be described individually or in detail.

However, it should be understood that suitable connection holes are formed in the components, to allow the components to be fastened together using bolts or similar connectors.

It is well within the knowledge and abilities of a person skilled in the art to form connection holes of appropriate sizes, in suitable places to allow components to be rigidly and reliably held together using bolts.

The squab connection struts 11 are connected to the squab side pieces 1, 2 by bolts. Preferably these bolts pass through the squab connection struts 11, and through the bottom plates 3. In the embodiment shown, a pair of bolts is used at each end of each squab connection strut 11. In the embodiment shown, anti-crush inserts 12 are provided within each end of each of the squab connection struts 11. The bolts which connect the squab connection struts 11 to the squab side pieces 1, 2 may also pass through these anti-crush inserts 12.

The anti-crush inserts 12 take the form of blocks, made from a robust material, which preferably fit closely within each end of the connection struts 11, and prevent the connection struts 11 from being crushed when the bolts are tightened.

FIG. 2 shows the squab side pieces 1, 2 and squab support struts 11 when connected together, to form a squab support 13.

Turning to FIG. 3, further components of a seat frame are shown.

A seat back frame 14 has left and right side elements 15, 16, which in use will connect to the squab support 13. In the embodiment shown the side elements 15, 16 are generally parallel with each other, and take the form of elongate struts. The upper ends 17 of the side elements 15, 16 are connected by an arched portion 18, which extends horizontally to connect the side support 15,16 to each other. In the example shown, the arched portion 18 comprises left and right inclined portions 19, 20, which are connected to the upper ends 17 of the side elements 15, 16, and are angled with respect thereto so that the upper ends 22 thereof are closer together than the side elements 15, 16. The upper ends 22 of the inclined portions 19, 20 are connected by a crossbar 23, which in the example shown is at right angles, or substantially right angles, to the side elements 15, 16.

The arched portion 18 need not take this exact configuration, and may have any suitable shape, as long as it robustly connects the side elements 15, 16 to each other while providing a frame which is of an appropriate shape to support the back of a vehicle seat.

In embodiments, the seat back frame may have a generally rectangular overall shape, with parallel side elements, connected at their top end by a crossbar which is perpendicular to the side elements. It is not necessary that the seat back frame is tapered at its top end, or that it has a conventional arch shape at its top end.

The side elements 15, 16, the angled portions 19, 20 and the crossbar 23 may be integrally formed, although in other examples the seat back frame 14 may be formed from two or more components which are formed separately and fixed together. In the embodiment shown, these components are formed from a single length of a tubular material, which is bent or angled in the appropriate places. In this example the tubular material has a rectangular cross-section, having a width which is longer than its depth. Each bend may be formed around an axis which is parallel or substantially parallel with the width of the tubular material at that point. The side elements 15, 16, the angled portions 19, 20 and the crossbar 23 together comprise a perimeter support of the seat frame 14.

In the example shown, the lower ends 24 of the left and right side elements 15, 16 are attached to the connection projections 7 of the squab side pieces 1, 2, and these connections include a series of energy absorbing crush plates 25. One of the crush plates 25 is shown in more detail in FIG. 4.

As can be seen in FIG. 4, each crush plate 25 takes the form of a strip of a robust material, such as steel. The strip is preferably generally planar, and preferably has a consistent thickness over its area, and in preferred embodiments each crush plate 25 may be cut or stamped from a continuous sheet of material.

In the example shown in the figures, the crush plate 25 has left and right side edges 35, 36, which are preferably parallel or generally parallel with each other. The crush plate 25 also has a bottom edge 37 and a top edge 38. In the example shown the bottom edge 37 is generally straight, and additionally or alternatively the top edge 38 has a curved shape, which is preferred but not essential. The curved or radiused shape of the top edge 38 helps to prevent the side elements 15, 16 from being damaged (e.g. split or fractured) during a collision, for reasons which will be understood from the description below.

The crush plate 25 has a connection aperture 39 formed therethrough. In the example shown the connection aperture 39 is formed close to the bottom edge 37. The connection aperture 39 preferably passes all the way through the depth of the crush plate 25.

A notch 40 is formed between the connection aperture 39 and one of the side edges (in the example shown, the right side edge 36) of the crush plate 25. The notch 40 takes the form of a cut-out portion of the crush plate 25. The connection aperture 39 is therefore not entirely enclosed, and communicates with the one side edge 36. The notch 40 preferably widens as it passes from the connection aperture 39 to the side edge 36, and is therefore generally V-shaped. The notch 40 has first and second edges 41, 42, which generally face each other.

As can be seen in FIG. 3, two crush plates 25 are provided on the left-hand side, and two further crush plates 25 are provided on the right hand side. In assembly of the seat, the crush plates 25 on the right had side are inserted into the hollow interior of the right side element 16, so that the connection apertures 39 thereof are aligned with a through hole formed through a lower part of the right side element 16.

The right side element 16 is then positioned so that the through hole is aligned with a connection hole formed through the offset region 8 of the connection projection 7 of the connection plate 4 of the right squab side piece 2. A bolt 43 is passed through the through hole of the right side element 16, and through the connection apertures 39 of the two crush plates 25 that are positioned within the right side element 16. The bolt passes through the connection hole formed in the offset region 8.

In this example, two crush plates 25 are provided on each side. This is not essential, and only one crush plate 25 may be provided on each side, or three or more crush plates may be provided on each side. It is not essential for the same number of crush plates to be provided on each side, although this is preferred, to avoid asymmetric movement of the sides of the seat, and/or twisting of the seat. In some examples there may be one or more crush plates on one side, and no crush plates on the other side.

In this example two crush plates are provided on each side, as this is convenient given the internal diameter of the tube forming the side elements 15, 16 and the thickness of the sheet of material from which the crush plates 25 are formed.

FIG. 5 shows the seat back frame 14 when fully connected to the squab support 13. Together these components comprise a seat frame 21.

FIG. 6 shows a close-up view of the connection between the right-hand squab side piece 2 and the right-hand side element 16, as indicated by the circle in FIG. 4.

As can be seen in this figure, at least a part of the bottom edge 37 of each crush plate 25 projects downwardly below the bottom of the right side element 16. In preferred embodiments, the bottom edge 37 lies on or near the upward-facing shoulder 44 formed in the right hand connection plate 4.

As is normal for vehicle seats, the seat back frame 14 is tilted backwards, so the plane of the seat back frame 14 is inclined with respect to the plane of the squab support 13 (i.e. the plane in which the squab support 3 will hold and support a cushion on which a seat occupant will sit). In embodiments of the invention, the angle of tilt of the seat back frame 14 with respect to the squab support 13 can be controlled by the angle at which these components are set with respect to each other before being bolted together. In one example, the angle of tilt of the seat back frame 14 with respect to the squab support is 96°, but any other suitable angle may be used.

Turning to FIG. 7, a further view of the seat frame 21 is shown, with a first cross-support 26 also shown.

In FIG. 7 the first cross-support 26 is shown detached from the remaining components of the seat frame 21.

In the example shown, the first cross-support 26 comprises an elongate straight or substantially straight strut portion 27. At its lower end 28, the first cross support 26 has a first angled connection portion 29. At its upper end 30 the first cross-support 26 has a second angled connection portion 31.

FIG. 8 shows the first cross-support 26 when connected to the remaining components of the seat frame 21. At its lower end 28, the first cross-support 26 is connected to the right-hand squab side piece 2, by its first angled connection portion 29. In the example shown, the first angled connection portion 29 is attached to the connection projection 7 of the right-hand squab side piece 2, by way of a bolt which passes through an aperture formed below the region where the right-hand side element 16 of the seat frame 14 attaches to the support projection 7. This connection is shown in more detail in FIG. 9, which shows the region indicated by circle in FIG. 8.

At its upper end 30, the first cross-support 26 is attached to an upper region of the opposite side of the arched portion 18. In the example shown, the upper end 30 of the first cross-support 16 is attached in the region of the junction between the crossbar 23 and the left-hand inclined portion 19. In general, at its upper end the first cross-support 26 is attached at, or in the region of, an upper corner of the seat back frame 14.

Turning to FIG. 10, a second cross-support 32 is shown. Once again the second cross-support 32 preferably takes the form of an elongate strut, having respective angled connection portions 33, 34 at its upper and lower ends.

The upper connection portion 33 is attached to the first cross-support 26, at a location part way along its length. The lower connection portion 34 is attached to the connection projection 7 of the left-hand squab side piece 1.

The second cross-support 32 therefore provides a further bracing function for the seat frame 21, stabilising the first cross-support 26, and providing additional support and rigidity to the seat back.

FIG. 10 shows the seat frame 21 in its substantially completed form.

As the skilled reader will appreciate, in use the seat frame 21 will be attached to the floor of a vehicle, and this may be done in any suitable way. One or more legs, or an alternative support arrangement, may be connected to the seat frame and to the vehicle floor. It is envisaged that the squab support 13 will be raised above the level of the vehicle floor to a suitable height for an occupant to sit comfortably in the seat, as is conventional.

If the seat frame 21 is installed in a vehicle as part of a seat, and the vehicle is involved in a head-on collision while an occupant is sitting in the seat, the occupant will be thrown forwardly with respect to the seat. If (as is expected) the occupant is wearing a seat belt, the seat belt will restrain forward motion of the occupant's torso (following locking of an inertia reel, if applicable).

A proportion of the occupant's forward momentum will therefore be transferred to the seat back frame 14, causing forces to act on the seat back frame that would tend to cause the seat back frame 14 to rotate forwardly with respect to the squab support 13.

If the forces involved are sufficiently high, the seat back frame 14 will begin to rotate forwardly, around the bolts 43 that connect the squab support 13 to the seat back frame 14. As this occurs, the bottom edge 37 of each crush plate 25 will abut against the upward-facing shoulder 44, and the bottom edge 37 of each crush plate 25 will therefore be prevented from further rotation. The shoulder 44 therefore acts as a bearing surface.

As the seat back frame continues to rotate forwardly, the crush plates 25 will deform, with the edges 41, 42 of the notch 40 being brought closer together, and the width of the slot reducing. Each crush plate 25 will pivot around the bolt 43 that passes through its connection aperture 39.

As this occurs a top portion of each crush plate 25, defined above the connection aperture 39, will rotate with respect to a bottom portion of the crush plate 25, defined below the connection aperture 39.

The amount of deformation of the crush plates 25 will depend on the forces arising, but the deformation may continue until the edges 41, 42 of the notch 40 meet each other, as shown in FIG. 11. In this state, the notch 40 has effectively closed.

As the crush plates 25 deform, energy is absorbed, and this will assist in protecting the occupant of the seat. A further advantage is that a portion of the load that would normally be transmitted to the floor of the vehicle through the legs of the seat is instead absorbed by the deformation of the crush plates 25.

The reader will appreciate that, after the crush plates 25 have deformed to the configuration shown in FIG. 11, the angle of the seat back frame 14 with respect to the squab support 13 will have changed. The seat back frame 14 will have rotated forwardly with respect to the squab support 13. In some embodiments, following deformation of the crush plates 25 in this way the seat back frame 14 will be at right angles or substantially at right angles with respect to the squab support 13.

In preferred embodiments of the invention, the crush plates 25 may deform to the condition shown in FIG. 11, in which the notch 40 has entirely or substantially entirely closed, without any significant damage to, or deformation of, any other components of the seat frame 21. The remaining components are sufficiently robust that they will not be deformed or damaged under forces which are sufficient to deform the crush plates 25 in this way.

The skilled reader will appreciate that references to deformation of the crush plates 25 in this document refers to permanent deformation. References to deformation should not be interpreted as including elastic deformation.

Following a certain amount of deformation, the edges 41, 42 of the notch 40 meet each other, as shown in FIG. 11. In preferred embodiments of the invention, when the edges 41, 42 come into contact with each other, this helps to prevent further significant deformation of the crush plate 25. Before the edges 41, 42 meet each other, the crush plate 25 may deform relatively easily, but once the edges 41, 42 have come into contact with each other, further deformation can only occur under very large forces.

The width of the notch 40 can therefore be selected to control a range of movement that the seat back frame 14 will undergo during a crash situation in which forces of a certain level act on the seat frame 21. The seat back frame 14 may rotate to some extent with respect to the squab support 3, to absorb energy and protect the occupant, but the seat back frame 14 is prevented from significant further rotation, which may be harmful to the occupant.

As can be seen in FIG. 4, in preferred embodiments the bottom edge 37 of each crush plate 25 is not perpendicular to the length of the crush plate 25, but is set at an angle with respect to the length of the crush plate 25. This allows the bottom edge 37 to engage, or be generally aligned with, the upward-facing shoulder 44 at the appropriate point during forward rotation of the seat back frame 14. In preferred embodiments, when the seat frame 21 is first assembled, i.e. before a collision has taken place, the bottom edge 37 lies close to, or rests against, the upward-facing shoulder 44. The skilled reader will understand how this angle may be selected, depending upon the configuration of the other components, and the desired angle of the seat back frame 14 with respect to the squab support 13.

For example, as mentioned above, in preferred embodiments, the initial angle between the seat back frame 41 and the squab support 3 may be 96°. In this example, therefore, the bottom edge 37 of the crush plate may be set at 96° to the right side edge 36, and at 84° to the left side edge 35.

Another preferred feature of the seat frame 21, and of other examples of seat frames embodying the invention, is that there are no welded connections between any of the components of the seat frame 21. In the example shown, all of the connections between the components are formed with bolts, although the skilled person will be aware of other mechanical connections, which do not involve welding, which may be used to connect some or all of the seat components together. Examples of alternative connectors include rivets and hank bushes.

There are several features of the seat frame 21 which allow it to be constructed effectively without the use of any welded joints.

Firstly, many of the components are formed from struts which have a planar form, i.e. which are significantly wider in a first direction than in a second, perpendicular direction. In the example shown in the figures, this is true of the bottom plates 3 and connection plates 4 of the squab side pieces 1,2, parts of the seat back frame 14, and the first and second cross-supports 26, 32. Struts having this configuration demonstrate high strength and resistance to bending within the plane of the material. These struts may be tubular in cross-section, or may be solid with no interior space.

While struts having this shape display less resistance to bending around an axis which is parallel with the plane of the strut, the fact that the seat comprises struts disposed at a variety of angles means that, where forces act on the seat, at least some of the struts are positioned to display strong resistance to bending as a result of these forces.

Forming the seat in this way therefore allows it to have the necessary strength, rigidity and resistance to bending, without needing to gain extra strength from the use of welded joints.

Secondly, the first cross-support 26 can be positioned so that its top end is positioned at or near the location where a seat belt connector is attached to the back of the finished seat. The seat may have a seat belt reel and retractor mechanism attached to a top corner thereof, or alternatively a loop or guide through which a seat belt passes, with the reel and/or retractor mechanism being positioned elsewhere (for instance, attached to a side wall or ceiling of a vehicle in which the seat is installed). In either case, in a crash situation, significant forces may be exerted on the top corner of the seat, as the seat occupant is thrown forwardly with respect to the seat, and is restrained in this motion by the seat belt.

The presence of the first cross-support will greatly assist in providing a high level of rigidity to the seat frame, to prevent excessive movement or deformation if this occurs.

A seat belt provided on the seat will also generally pass diagonally, from one top corner of the seat back to the opposite lower corner of the seat back (e.g. in a conventional “lap and diagonal” seat belt). The first cross-support 26 connects these two corners of the seat back, thus specifically providing rigidity between the two connection points of the diagonal part of the seat belt, where the greatest forces will be exerted on the seat frame by an occupant during a head-on type collision.

Therefore, once again the strength of the seat frame can be very high, without requiring the use of welded joints.

The second cross-support 32 also provides important rigidity to the seat frame 21, and helps to maintain the first cross-support 26 in its correct position and configuration during a crash situation or other event in which large forces act on the seat frame 21.

Further, the connection between the seat back frame 14 and the squab support 3 described above, including deformable crush plates 25, allows the seat to protect an occupant, in a way that would not be possible with a conventional welded connection between these components.

Avoiding welded joints provides several advantages.

Welding is a skilled and time-consuming process, and in some manufacturing facilities welding operations can often be the step that holds up overall production, as otherwise finished components wait to be joined together by welders.

Welding can also be unreliable. Sometimes a joint will not have been welded completely, with the result that it will be unreliable and prone to failure under large forces. Such an incomplete weld will be difficult or impossible to detect by inspection.

By contrast, where a connection made by bolts or similar fasteners, the sturdiness of the connection can readily be verified by inspection, and if a bolt is not fully fastened then it can easily and rapidly be fastened using appropriate tools.

In the example shown in the figures, the first cross-support 26 extends from the right-hand squab side piece to the top left-hand corner of the seat back frame 14. This will be appropriate for a seat which is to be positioned on the left-hand side of a vehicle, as it will extend between the points on the seat frame where the diagonal part of the seat belt is attached. The skilled person will appreciate that, for a seat which is to be positioned on the right-hand side of a vehicle, the first cross-support can be installed in the opposite configuration, i.e. extending from the left-hand squab side piece to the top right-hand corner of the seat back frame. The position of the second cross-support can be similarly changed, to extend from the right-hand squab side piece to a central region of the first cross-support.

While it is preferred that a seat embodying the invention has no welded connections, it should be understood that the benefits of this can be obtained separately from those of the crush plates described above. A seat frame embodying the invention can, if necessary, include the crush plates, but also have one or more welded connections. A seat frame embodying the invention can also have no welded connections, but need not necessarily include the crush plates.

The skilled reader will appreciate that the seat frames described above will be relatively straightforward to construct, and will perform robustly and reliably to protect occupants in the event of a crash.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A seat frame, comprising:
a squab support;
a seat back frame, fixed in place with respect to the squab support at a first angle by a fastener; and
a deformable element having an upper portion and a lower portion and an aperture through which the fastener passes, wherein:
the deformable element further has a gap having an initial width, the gap being formed between the upper and lower portions;
the deformable element may permanently deform, upon rotation of the seat back frame with respect to the squab support around the fastener, so that the upper and lower parts of the deformable element rotate with respect to each other about the fastener, and the width of the gap reduces, so that the seat back frame is at a second angle with respect to the squab support.

2. A seat frame according to claim 1, wherein the upper portion of the deformable element is engaged with a part of the seat back frame.

3. (canceled)

4. A seat frame according to claim 1, wherein the lower portion of the deformable element is engaged with a part of the squab support.

5. A seat frame according to claim 4, wherein the lower portion of the deformable element abuts or is adjacent a part of the squab support.

6. (canceled)

7. A seat frame according to claim 1, wherein the gap has opposing edges, which are spaced apart from each other when the gap has the initial width, and wherein the edges move closer to each other upon deformation of the deformable element.

8. A seat frame according to claim 7 wherein, following a certain amount of deformation of the deformable element, the edges of the gap meet and abut against each other, thus providing increased resistance to further deformation of the deformable element.

9. A seat frame according to claim 1, wherein the fastener passes through an aperture in the deformable element, and the gap is in communication with the aperture.

10. A seat frame according to claim 1, wherein one or more deformable elements are provided on each side of the seat frame.

11. (canceled)

12. A seat frame according to claim 1, comprising a first cross-support, which is connected at a first end to an upper region of the seat back frame, and is connected at a second end to the squab support.

13. (canceled)

14. A seat frame according to claim 12, further comprising a second cross-support, which is connected at a first end to the first cross-support, and at a second end to the squab support.

15. (canceled)

16. A seat frame according to claim 14, wherein the first cross-support is connected at its second end to a first side of the squab support, and the second cross-support is connected at its second end to a second, opposite side of the squab support.

17. A seat frame comprising:
a squab support;
a seat back frame, fixed in place with respect to the squab support;
a first cross-support, extending diagonally across the seat back frame; and
a second cross-support, extending diagonally across the seat back frame and terminating at one end in a connection to the first cross-support.

18. A seat frame according to claim 17, wherein:
the seat back frame comprises a perimeter support;
the first cross-support is connected to the perimeter support at an upper end thereof; and
the first cross-support is connected to the squab support at a lower end thereof.

19. A seat frame according to claim 17, wherein:
the second cross-support is connected to the first cross-support at an upper end thereof; and
the second cross-support is connected to the squab support at a lower end thereof.

20. A seat frame according to claim 17, having no welded connections joining the squab support to the seat back frame.

21. A seat comprising a seat frame according to claim 17.

22. (canceled)

23. A vehicle comprising a seat according to claim 21.

24. A seat comprising a seat frame according to claim 1.

25. A vehicle comprising a seat according to claim 24.

26. A seat comprising a seat frame according to claim 20, having no welded connections between any of the components thereof.
